(19) United States
(12) Patent Application Publication
(10) Pub. No.: US 2026/0235507 A1
(43) Pub. Date: Aug. 13, 2026

(54) SYSTEM AND METHOD FOR PARAMETRIC DETECTION OF BROADBAND TERAHERTZ PULSES

(71) Applicants: ECOLE DE TECHNOLOGIE SUPERIEURE, Montréal (CA); NATIONAL UNIVERSITY CORPORATION TOKAI NATIONAL HIGHER EDUCATION AND RESEARCH SYSTEM, Aichi (JP)

(72) Inventors: François BLANCHARD, Montreal (CA); Sota MINE, Aichi (JP); Kosuke MURATE, Aichi (JP)

(21) Appl. No.: 19/471,833

(22) PCT Filed: Apr. 5, 2024
(86) PCT No.: PCT/CA2024/050440

§ 371 Date: Oct. 2, 2025

Related U.S. Application Data
(60) Provisional application No. 63/494,718, filed on Apr. 6, 2023.

(51) Int. Cl. G01N 21/3581; G02F 1/355; G02F 1/39; H01S 3/00

(52) U.S. Cl. CPC G01N 21/3581; G02F 1/3551; G02F 1/392; H01S 3/0057; G02F 2203/13

(57) ABSTRACT

A system for terahertz pulse detection comprises an optical medium made of a nonlinear material, a broadband laser source configured to emit laser pulses towards a first side face of the optical medium, along a first direction normal to the first side face, and a terahertz radiation emitter configured to emit terahertz radiation towards an upper face of the optical medium, along a second direction at a first non-zero angle relative to the first direction. The laser pulses and the terahertz radiation synchronously propagate within the optical medium and interact with one another and with the optical medium to generate up-converted signals that exit the optical medium at a second side face opposite the first side face, along third directions at second non-zero angles relative to the first direction. An image acquisition device captures at least one image of the up-converted signals.

### CROSS-REFERENCE TO RELATED APPLICATIONS

The present application claims priority on U.S. Patent Application No. 63/494,718 filed Apr. 6, 2023, the entire contents of which are incorporated herein by reference.

### FIELD

The improvements generally relate to the field of pulse detection, and more specifically of parametric detection of broadband terahertz pulses.

### BACKGROUND

Characterization of properties of matter in the terahertz (THz) frequency range can be performed using terahertz time-domain spectroscopy (THz-TDS). Conventional TD-THz techniques (so-called “pump-probe” approaches) comprise, at the transmitter side, a terahertz emitter that converts a short laser pulse into terahertz radiation. On the receiver side, the terahertz radiation is sampled with a time-shifted copy of the laser pulse. This technique usually involves a time delay, which is either realized with a mechanical stage or by synchronizing the pulse trains of two lasers. However, the time delay remains the bottleneck in terms of attainable data rates and existing techniques are simply not fast enough for widespread industrial use. In addition, these techniques usually require the introduction of a modulator and a lock-in amplifier to improve the low signal-to-noise ratio of the signals being measured.

Thus, there remains room for improvement.

### SUMMARY

In accordance with one aspect, there is provided a system for terahertz pulse detection. The system comprises an optical medium having an upper face, a first side face, and a second side face opposite the first side face, the optical medium made of a nonlinear material. The system also comprises a broadband laser source configured to emit a plurality of laser pulses towards the first side face of the optical medium, along a first direction normal to the first side face, and a terahertz radiation emitter configured to emit terahertz radiation towards the upper face of the optical medium, along a second direction at a first non-zero angle relative to the first direction. The plurality of laser pulses and the terahertz radiation are configured to synchronously propagate within the optical medium and to interact with one another and with the optical medium to generate a plurality of up-converted signals that exit the optical medium at the second side face, along a plurality of third directions at a plurality of respective second non-zero angles relative to the first direction. The system further comprises an image acquisition device configured to capture at least one image of the plurality of up-converted signals.

In some embodiments, the plurality of laser pulses and the terahertz radiation are configured to interact with one another and with the optical medium to generate the plurality of up-converted signals through an optical parametric amplification process.

In some embodiments, the optical medium is made of the nonlinear material selected from the group consisting of lithium niobate (LiNbO₃), lithium tantalite (LiTaO₃), and lithium triborate (LiB₃O₅).

In some embodiments, the laser source is a femtosecond laser configured to generate a plurality of femtosecond laser pulses.

In some embodiments, the laser source is one of an Ytterbium-doped laser, a Ti:Sapphire laser, and an Erbium laser.

In some embodiments, the image acquisition device is one of a charge-coupled device (CCD) camera and a scientific-grade complementary metal-oxide-semiconductor (sCMOS) camera.

In some embodiments, the system further comprises a coupling medium for coupling the terahertz radiation to the optical medium, the terahertz radiation emitter configured to input the terahertz radiation into the optical medium through the coupling medium.

In some embodiments, the coupling medium is a triangular-shaped silicon prism positioned on the upper face of the optical medium.

In some embodiments, the system further comprises at least one optical device configured to collect the terahertz radiation emitted by the terahertz radiation emitter and to collimate and refocus the terahertz radiation onto the optical medium.

In some embodiments, the at least one optical device comprises an off-axis mirror unit positioned at a distance from the optical medium.

In some embodiments, the system further comprises a diffraction grating positioned at a distance from the optical medium, the diffraction grating configured to receive a pulse front comprising the plurality of up-converted signals exiting the optical medium and to diffract the plurality of up-converted signals to generate an inclined pulse front, where wavelength components associated with the pulse front are spatially separated along a first axis through the optical parametric amplification process, and the wavelength components associated with the inclined pulse front are separated by the diffraction grating along a second axis perpendicular to the first axis.

In some embodiments, the system further comprises a chirping device and a diffraction grating interposed between the laser source and the optical medium, where the chirping device is configured to receive the plurality of laser pulses from the laser source and to output a chirped pump beam to the diffraction grating, and the diffraction grating is configured to diffract the chirped pump beam to generate a spectral chirped beam for input into the optical medium.

In some embodiments, the system further comprises a lens interposed between the optical medium and the image acquisition device, the lens configured to spatially separate the plurality of up-converted signals that exit the optical medium for imaging the up-converted signals onto the image acquisition device.

In accordance with another aspect, there is provided a system for terahertz pulse detection. The system comprises an optical medium having an upper face, a first side face, and a second side face opposite the first side face, the optical medium made of a nonlinear material, and a broadband laser source configured to emit a plurality of laser pulses towards the first side face of the optical medium, along a first direction normal to the first side face. The system also comprises a terahertz radiation emitter configured to emit terahertz radiation towards the upper face of the optical medium, along a second direction at a first non-zero angle relative to the first direction. The plurality of laser pulses and the terahertz radiation are configured to synchronously propagate within the optical medium and to interact with one another and with the optical medium to generate a plurality of up-converted signals that exit the optical medium at the second side face, along a plurality of third directions at a plurality of respective second non-zero angles relative to the first direction. The system further comprises an image acquisition device configured to capture at least one image of the plurality of up-converted signals.

In some embodiments, the plurality of laser pulses and the terahertz radiation interact with one another and with the optical medium to generate the plurality of up-converted signals through an optical parametric amplification process.

In some embodiments, emitting the terahertz radiation comprises coupling the terahertz radiation to the optical medium via a coupling medium.

In some embodiments, the method further comprises using at least one optical device to collect the terahertz radiation emitted by the terahertz radiation emitter and to collimate and refocus the terahertz radiation onto the optical medium.

In some embodiments, the method further comprises receiving, at a diffraction grating, a pulse front comprising the plurality of up-converted signals exiting the optical medium, wherein wavelength components associated with the pulse front are spatially separated along a first axis through the optical parametric amplification process, and diffracting, at the diffraction grating, the plurality of up-converted signals to generate an inclined pulse front, wherein the wavelength components associated with the inclined pulse front are separated along a second axis perpendicular to the first axis.

In some embodiments, the method further comprises receiving, at a chirping device, the plurality of laser pulses from the laser source and outputting a chirped pump beam to a diffraction grating, and diffracting, at the diffraction grating, the chirped pump beam to generate a spectral chirped beam for input into the optical medium.

In some embodiments, the method further comprises spatially separating, using a lens interposed between the optical medium and the image acquisition device, the plurality of up-converted signals that exit the optical medium for imaging the up-converted signals onto an image acquisition device configured to capture the at least one image of the plurality of up-converted signals.

Many further features and combinations thereof concerning embodiments described herein will appear to those skilled in the art following a reading of the instant disclosure.

### DESCRIPTION OF THE FIGURES

In the figures,

FIG. 1A is a schematic diagram of an example system for parametric detection of terahertz pulses, in accordance with one embodiment;

FIG. 1B is a detailed view of the up-converted signals of FIG. 1A, in accordance with one embodiment;

FIG. 2A is a schematic diagram of an example system for parametric detection of terahertz pulses, in accordance with another embodiment;

FIG. 2B is a schematic diagram of an example system for parametric detection of terahertz pulses, in accordance with yet another embodiment;

FIG. 3 is a schematic diagram of an example system for parametric detection of terahertz pulses using a lens, in accordance with one embodiment;

FIG. 4A illustrates the up-converted signal induced by the broadband terahertz pulses generated by the system of FIG. 2B and its background information without terahertz waves, in accordance with one embodiment;

FIG. 4B illustrates the time projection of the up-converted signal of FIG. 4A captured at 50 frames per second (FPS) after removing the background information, in accordance with one embodiment;

FIG. 5A is a schematic diagram of an example system for parametric detection of terahertz pulses using diffraction grating, in accordance with one embodiment;

FIG. 5B is a schematic diagram illustrating the overlap of adjacent wavelength components with no diffraction grating as in FIG. 5A, in accordance with one embodiment;

FIG. 5C is a schematic diagram illustrating the separation between wavelength components achieved using the diffraction grating of FIG. 5A, in accordance with one embodiment;

FIG. 6 is a schematic diagram of an example system for parametric detection of terahertz pulses using a chirped pump beam, in accordance with one embodiment;

FIG. 7 is a flowchart of an example method for parametric detection of terahertz pulses, in accordance with one embodiment, in accordance with one embodiment; and

FIG. 8 is a block diagram of an example computing device, in accordance with an illustrative embodiment.

It will be noticed that throughout the appended drawings, like features are identified by like reference numerals.

### DETAILED DESCRIPTION

Described herein are systems and methods for detection of broadband terahertz pulses. As will be described further below, detection is performed through a parametric up-conversion process in a non-collinear phase matching geometry, using a nonlinear crystal and a broadband pulse laser source. Using the systems and methods described herein, spatial separation by frequency may be achieved using the angular phase matching condition. The systems and methods described herein may be used for various applications including, but not limited to, communications, signal detection, spectroscopy, imaging, and non destructive testing (NDT) in industrial settings.

As used herein, the term “terahertz” encompasses frequencies that lie near the commonly accepted boundaries of the terahertz region of the electromagnetic spectrum, which is at the far end of the infrared (IR) band, after the end of the microwave band. The terahertz region corresponds to millimeter and submillimeter wavelengths between about 3 mm and about 0.03 mm. As used herein, the terahertz region should be understood to be between about 0.1 THz to about 10 THz.

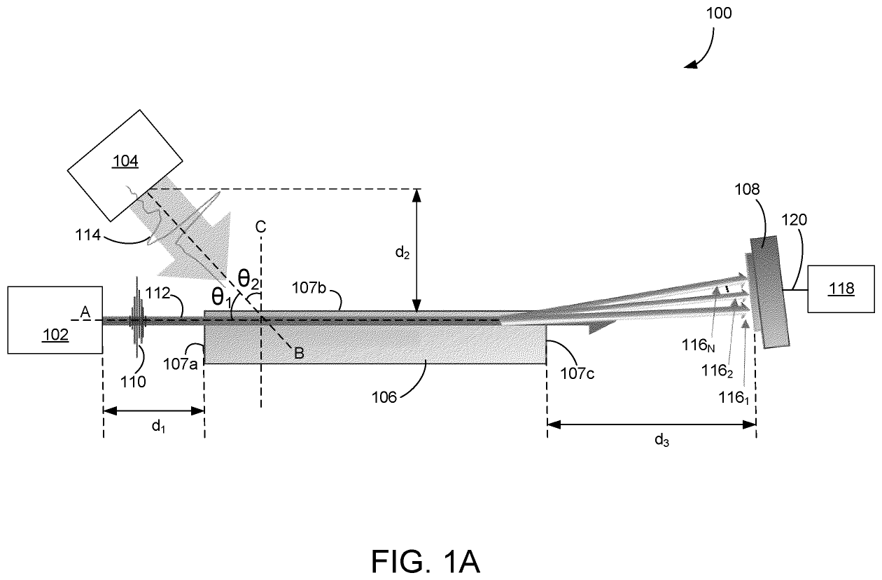

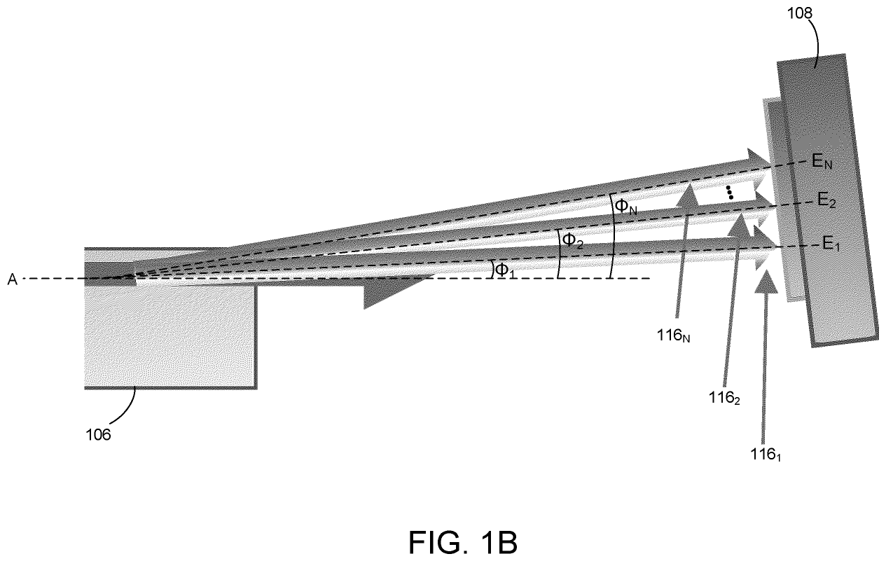

Referring to FIG. 1A, an embodiment of a system 100 for parametric detection of terahertz pulses will now be described. The system 100 comprises a laser source 102, a terahertz radiation emitter 104, a substantially elongated optical medium 106 (also referred to herein as a “nonlinear optical medium”) made of a nonlinear material, and an image acquisition device 108. The system 100 may be used to convert terahertz waves (generated by the terahertz radiation emitter 104) into visible (e.g., near infrared or NIR) light by parametric wavelength conversion. As will be described further below with reference to FIG. 1B in addition to FIG. 1A, due to the angular phase matching condition between each terahertz wave and each laser pulse (generated by the laser source 102), the angle at which signals output from the optical medium 106 differs for each frequency of the terahertz wave so that the information from each frequency can be separated and detected in real time using the image acquisition device 108.

As used herein, the term “nonlinear”, when used in reference to an optical medium or a material, refers to the fact that the optical response of the optical medium or material depends on the intensity of the optical field propagating into the optical medium or material. In particular, the refractive index of the optical medium or material changes with the intensity of the incident light. One example of a nonlinear optical medium is a nonlinear optical crystal (also referred to as a “parametric detection crystal”). In one embodiment, the nonlinear optical medium 106 is shaped as a rectangular cuboid (e.g., a slab) extending along a direction A and comprising a first side face (also referred to herein as an “input face”) 107a, an upper face 107b, and a second side face (also referred to herein as an “output face”) 107c opposite the input face 107a. The faces 107a, 107b, and 107c are substantially planar. The laser source 102 is positioned at a first distance d₁ from the input face 107a, the terahertz radiation emitter 104 is positioned at a second distance d₂ from the upper face 107b, and the image acquisition device 108 is positioned at a third distance d₃ from the output face 107c.

The laser source 102 is configured to generate laser pulses as in 110 (also referred to herein as a “train of pulses” or a “pulse train”). For sake of simplicity, a single laser pulse 110 is illustrated in FIG. 1A. The laser pulse 110 may be referred to as a near infrared (NIR) “pump pulse” and the plurality of laser pulses 110 generated by the laser source 102 may together be referred to as a “pump beam”. In some embodiments, the laser source 102 may be configured to generate laser pulses 110 having a pulse duration in the order of femtoseconds (fs). For example, the laser source 102 may be a compact fiber-based femtosecond (fs) laser. Various laser technologies may be considered, including, but not limited to, gas lasers, solid-state lasers, liquid lasers, and semiconductor lasers. For example, Ti: Sapphire, Ytterbium-doped, Erbium, and other femtosecond lasers may apply. The parameters associated with the laser source 102 and/or the train of pulses 110 (e.g., frequency, duration, halfwidth, repetition rate, energy, output power, center wavelength, and the like) may vary depending on the application. In one embodiment, the laser source 102 is an Ytterbium laser emitting pulses of 300 fs at 1.022 μm with an energy of 400 μJ and a maximal repetition rate of 25 kHz. In this configuration, a few μJ are used for illumination. Other embodiments may apply. Other laser wavelengths can indeed be used, provided that the nonlinear medium 106 (e.g., the nonlinear crystal) transmits these waves.

As illustrated in FIG. 1A, the laser source 102 is configured to emit the laser pulses 110 towards the input face 107a of the nonlinear medium 106, along the direction A, for the laser pulses 110 to be input to the nonlinear medium 106 through the input face 107a. The direction A follows (i.e. is parallel to) the normal (not shown) to the input and output faces 107a, 107b. The laser source 102 may be optically coupled to the nonlinear medium 106 in any suitable manner. In some embodiments, the successive laser pulses 110 may propagate from the laser source 102 through a light-conducting fiber assembly 112, which directs the laser pulses 110 towards the nonlinear medium 106. The fiber assembly 112 may use any suitable technique or technology and may be configured to attenuate the pulses 110 (in order to decrease the output power thereof to any suitable value) and/or to modify the shape of the pulses 110 before the train of pulses 110 is passed to the nonlinear medium 106. While a fiber assembly 112 is shown and described herein, it should be understood that this is for illustrative purposes only and that the laser source 102 may be optically coupled to the nonlinear medium 106 in any suitable manner, such as via air.

Still referring to FIG. 1A, the terahertz radiation emitter 104 is configured to generate a terahertz radiation beam 114 (also referred to herein as an “incident terahertz radiation beam”) to be incident on the nonlinear medium 106 non-collinearly, i.e. at an angle different from that at which the laser pulse 110 is incident on the nonlinear medium 106. In particular, the terahertz radiation emitter 104 emits the terahertz radiation beam 114 towards the nonlinear medium 106 along a direction B. The direction B is at an angle θ₁ to the direction A at which the laser pulse 110 is incident on the nonlinear medium 106, and at an angle θ₂ (with θ₁=90°−θ2) to the normal C of the non-linear medium 106 (i.e. the normal to the upper face 107b). The values of the angles θ₁, θ₂ are selected such that the laser pulse 110 intersects the incident terahertz radiation beam 114 in phase at the entrance of the non-linear medium 106. In some embodiments, θ₂ is substantially equal to forty degrees (40°). Other embodiments may apply.

The incident terahertz radiation beam 114 has a spectrum containing frequencies within the terahertz region. In some embodiments, the spectral width of the incident terahertz radiation beam 114 may range from about 0.1 THz to about 5 THz, preferably from about 0.1 THz to about 2 THz, and more preferably from about 0.5 THz to about 1.5 THz. In some embodiments, the terahertz radiation emitter 104 is a broadband emitter such that the incident terahertz radiation beam 114 is a single pulse or a complex pulse shape, such as a train of pulses. The terahertz radiation emitter 104 may comprise any suitable terahertz pulse generator. In some embodiments, the terahertz radiation emitter 104 may comprise one or more electronically-based terahertz pulse emitters, such as THz pulse emitters using Complementary metal-oxide-semiconductor (CMOS) technology. Terahertz via spintronic emitters (which do not require any specific polarization for emitting THz pulses) may also be used. In one embodiment, the terahertz radiation emitter 104 has 400 kV/cm at focus and an average power of about 70 mW. It should however be understood that the characteristics of the terahertz radiation emitter 104 and of the incident terahertz radiation beam 114 may vary depending on the application.

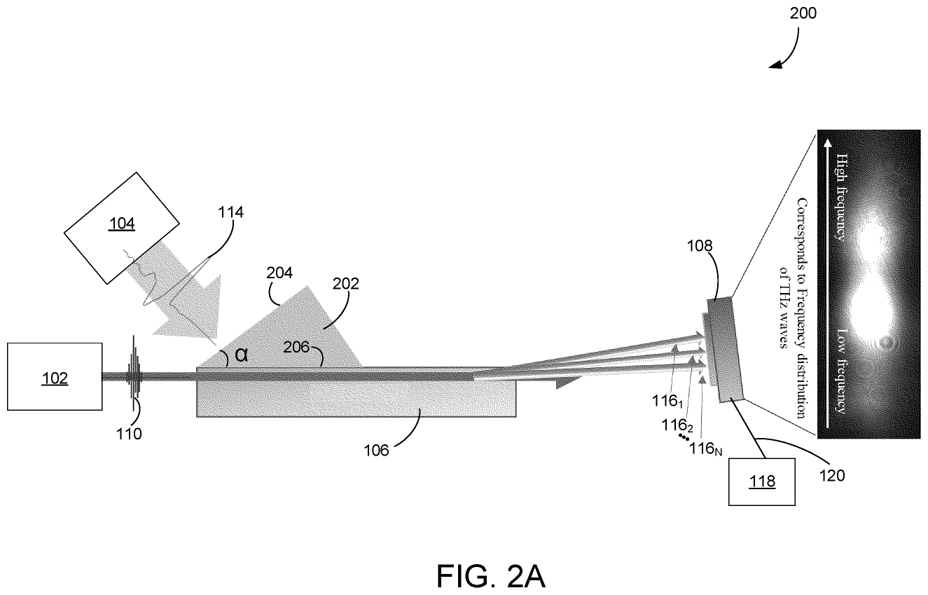

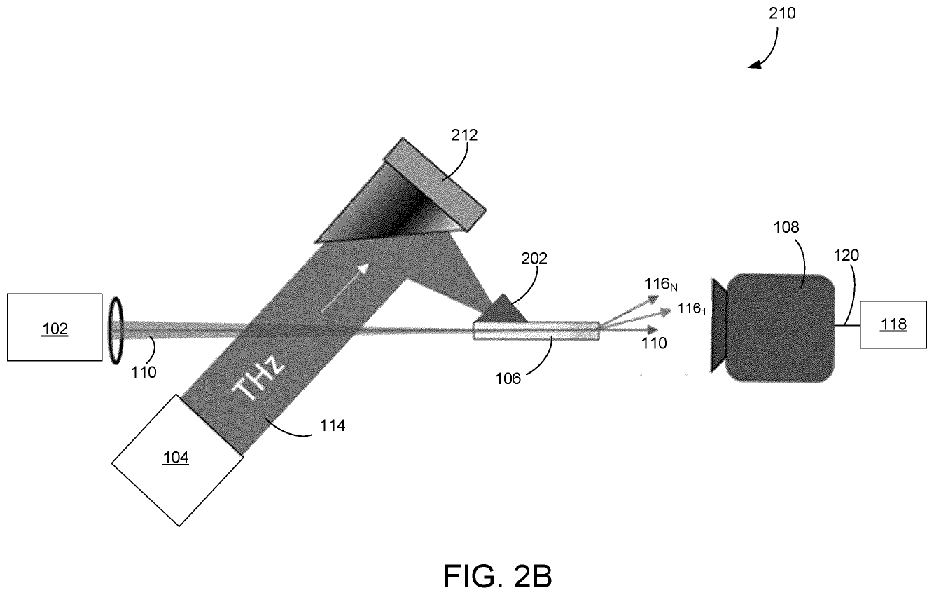

It should also be understood that the terahertz radiation emitter 104 may be optically coupled to the nonlinear medium 106 via any suitable means. In one embodiment, the terahertz radiation emitter 104 may be optically coupled to the nonlinear medium 106 via air (e.g., as illustrated in FIG. 1A) or vacuum. In another embodiment, a material transparent to terahertz radiation may be positioned on the upper face 107b of the nonlinear medium 106 to couple the terahertz radiation emitter 104 to the nonlinear medium 106. In the example illustrated in FIG. 2A, a system 200 for parametric detection of terahertz pulses is illustrated in which such a material comprises a triangular-shaped silicon (Si) prism 202 configured to optically couple the incident terahertz radiation beam 114 to the nonlinear medium 106. The prism 202 may have any suitable apex angle a and may be secured to the nonlinear medium 106 using any suitable means. The apex angle a corresponds to the angle between the first surface 204 at which the incident terahertz radiation beam 114 enters the prism 202 and the second surface 206 that the light encounters, i.e. the interface 206 between the prism 202 and the nonlinear medium 106. In one embodiment, the prism 202 is positioned relative to the nonlinear medium 106 such that the incident terahertz radiation beam 114 is normal to the surface 204 of the prism 202. While a prism 202 is illustrated and described herein, it should be understood that any other suitable coupling medium that is transparent to terahertz radiation including, but not limited to, germanium (Ge), and gallium arsenide (GaAs), may apply.

FIG. 2B illustrates a system 210 for parametric detection of terahertz pulses in accordance with another embodiment. In this embodiment, the incident terahertz radiation beam 114 may be collected at any suitable distance (e.g., about 84 mm) from the nonlinear medium 106 and focused prior to being input thereto. This may be achieved using any suitable optical device, such as an off-axis mirror (OAM) unit 212 as illustrated in FIG. 2B. The OAM unit 212 may comprise an off-axis ellipsoidal mirror (OAEM) and a pair of gold-coated off-axis parabolic mirrors (OAPMs) used to collimate and refocus the terahertz radiation onto the nonlinear medium 106. For example, the 12-498 OAEM from Edmund Optics™, having 65 degrees, 33 mm focal length, and 31.75 mm square aperture, and OAPMs each having a diameter of 2 inches and respective focal lengths of 4 and 2 inches may be used. It should however be understood that other embodiments may apply and, while an OAM unit 212 is illustrated and described herein, a lens or any other suitable device may be used to focus the incident terahertz radiation beam 114 from free space to a given focal point, prior to injection thereof into the nonlinear medium 106.

Still referring to FIG. 1A, the nonlinear medium 106 may be made of any suitable nonlinear material that is transparent to pump (i.e. laser pulses) and terahertz radiation. Such a nonlinear material includes, but is not limited to, lithium niobate (LiNbO₃), lithium tantalite (LiTaO₃), and lithium triborate (LiB₃O₅). For example, the nonlinear medium 106 may be a slab of lithium niobate crystal. It should also be understood that the properties (e.g., type, shape, size, length, phase-matching configuration, and the like) of the nonlinear medium 106 may vary depending on the application.

The laser pulses 110 (i.e. the pump beam) and the incident terahertz radiation beam 114 propagate synchronously within the nonlinear medium 106 where they interact with one another and with the nonlinear medium 106 to generate multiple (N) parametrically “up-converted signals” 116₁, 116₂, . . . , 116_{N}, which are output, along with the laser pulse 110 having propagated through the nonlinear medium 106, through the output face 107c of the nonlinear medium 106. The up-converted signals 116₁, 116₂, . . . , 116_{N} correspond to multiple optical paths that are generated as a result of a nonlinear optical effect referred to as “optical parametric amplification” (OPA). OPA is an optical process that occurs in nonlinear materials (such as the nonlinear medium 106) subjected to an intense pump beam (i.e. having a peak power of about 3 GW) produced by a femtosecond source (such as the laser pulse 110 generated by the laser source 102). In parametric processes, the pump beam interacts with the nonlinear material to create new optical frequencies, referred to as “Stokes frequencies”. With the injection of terahertz photons (from the incident terahertz radiation beam 114), the new optical frequencies create additional signals (referred to herein as “up-converted signals” through sum and difference frequency processes (i.e. based on the difference between the k-vectors of the laser pulse 110 and the k-vectors of the terahertz photons from the incident terahertz radiation beam 114). The additional signals are amplified as they propagate through the nonlinear material (i.e., the up-conversion process allows for new photons proportional to the number of injected terahertz photons to appear) and several amplification steps are possible without adding significant noise, producing a sensitive and measurable way to detect terahertz photons in the Stokes frequency band.

In the embodiment of FIG. 1A, after having propagated through the nonlinear medium 106, the laser pulse 110 is output from the nonlinear medium 106 without any angular deviation or separation (i.e. along the direction A). In contrast, the up-converted signals 116₁, 116₂, . . . , 116_{N} exhibit an angular separation, i.e. are spatially shifted from the direction A by different angles Φ₁, Φ₂, . . . , Φ_{N} and output from the nonlinear medium 106 along different directions E₁, E₂, . . . , E_{N}, as illustrated in FIG. 1B. In this manner, the up-converted signals 116₁, 116₂, . . . , 116_{N} are geometrically separated from the laser pulse 110. In other words, spatial separation of signal and pump beam can be achieved with optical pumping by the broadband laser source 102. Indeed, due to the low dispersion of NIR light and the high dispersion of terahertz waves in the nonlinear optical medium 106 (particularly in lithium niobate crystals), the multiple k-vectors contained in the broadband laser pulse 110 will be nearly identical and the NIR signal's frequency separation is almost solely determined by the k-vector of the incident terahertz radiation beam 114. In other words, the IR photons generated by OPA are spatially separated as a function of terahertz frequency regardless of the bandwidth of the laser pulse 110. The angles Φ₁, Φ₂ . . . , Φ_{N} are proportional to the frequency and the intensity of the incident terahertz radiation beam 114 and may therefore vary depending on the incident terahertz radiation beam 114. For example and as shown in FIG. 1B, the first up-converted signal 116₁ (e.g., corresponding to the Stokes frequency of 1 THz) may be generated at a first angle Φ₁ relative to the direction A, the second up-converted signal 116₂ (e.g., corresponding to the Stokes frequency of 1.5 THz) may be generated at a second angle Φ₂ relative to the direction A, a third up-converted signal (not shown, e.g. corresponding to the Stokes frequency of 2 THz) may be generated at a third angle (not shown) relative to the direction A, and the Nth up-converted signal 116_{N} may be generated at an n-th angle Φ_{N} relative to the direction A.

Still referring to FIG. 1A, the image acquisition device 108 is configured to record (i.e. capture an image of), in real time, the up-converted signals 116₁, 116₂, . . . , 116_{N}. induced by the incident terahertz radiation beam 114. The image acquisition device 108 is also configured to record (i.e. capture an image of), in real time, the laser pulse 110 exiting at the output face 107c. Any suitable image acquisition device 108 including, but not limited to, a charge-coupled device (CCD) camera comprising a matrix of photodiodes, a scientific-grade complementary metal-oxide-semiconductor (sCMOS) camera, and the like, may apply. For example, the sCMOS pco.edge 5.5™ camera model, which consists of 2560×2160 pixels of 6.5×6.5 μm² each, may be used as the image acquisition device 108. In this example, 16-bit depth images may be captured at 100 frames per second through a camera link interface (not shown).

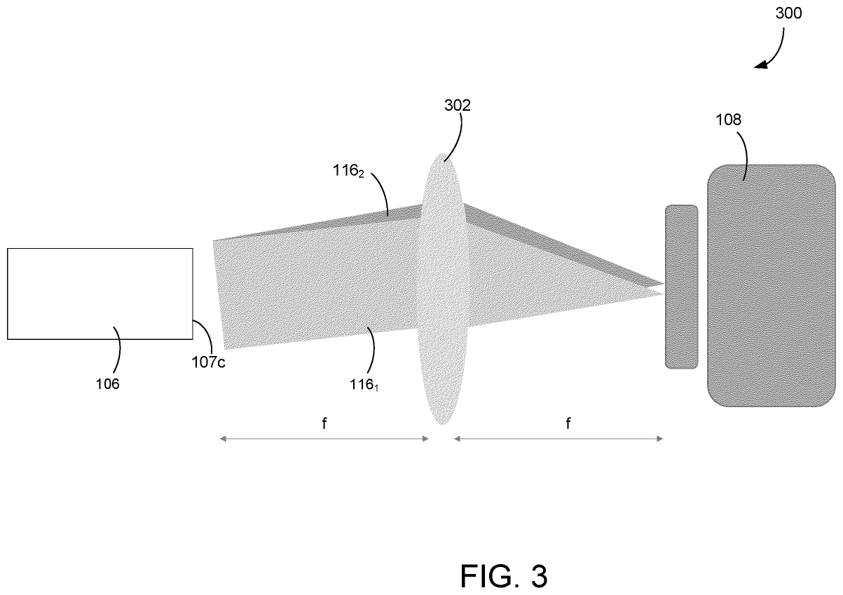

FIG. 3 illustrates an embodiment of a system 300 for parametric detection of terahertz pulses in which a lens 302 is used to image the up-converted signals (reference 116₁, 116₂, . . . , 116_{N} in FIG. 1A) onto the image acquisition device 108. For sake of clarity, only two (2) up-converted signals 116₁, 116₂ are shown in FIG. 3. The lens 302 is interposed between the nonlinear medium 106 and the image acquisition device 108. In one embodiment, each of the nonlinear medium 106 and the image acquisition device 108 is spaced from the lens 302 by a distance (f) equal (or substantially equal) to the focal length of the lens 302. Using the lens 302, the up-converted signals as in 116₁, 116₂ can be spatially reproduced (i.e. spatially separated). This may in turn enhance the resolution of the terahertz frequencies imaged by the image acquisition device 108 via its corresponding infrared signals. Any suitable lens 302 may be used, depending on the application (e.g., depending on the desired level of magnification to be achieved). For example, a 100 mm lens or a 200 mm lens may be used.

As illustrated in FIGS. 1A, 2A, and 2B, in some embodiments, the system 100 may comprise a computing unit 118 communicatively coupled to the image acquisition device 108 via any suitable communication means, such as a transmission link 120. In some embodiments, transmission link 120 may be wired, wireless, or a combination of wired and wireless connections. The transmission link 120 may comprise a communications cable, for instance coaxial cable, twisted pair cable, or fiber optic cable, among other possibilities. In some embodiments, the transmission link 120 may be provided as part of a network (not shown), which may be any type of network or combination of networks for carrying data communications. Such a network may comprise, for example, a Personal Area Network (PAN), Local Area Network (LAN), Wireless Local Area Network (WLAN), Metropolitan Area Network (MAN), or Wide Area Network (WAN), such as the Internet, or combinations thereof. In some embodiments, the image acquisition device 108 may communicate with the computing unit 118 via a private network (e.g. an “intranet”).

The computing unit 118 may be configured to record and process the data received from the image acquisition device 108. For example, the computing unit 118 may record the received data in a memory (not shown) associated therewith and accessible thereto. The computing unit 118 may process the received data by running computer-executable instructions to perform analysis (e.g., spectral analysis) on the data. The computing unit 118 may be configured to output, in any suitable manner, data at any time during the recording and/or processing of the data received from the image acquisition device 108.

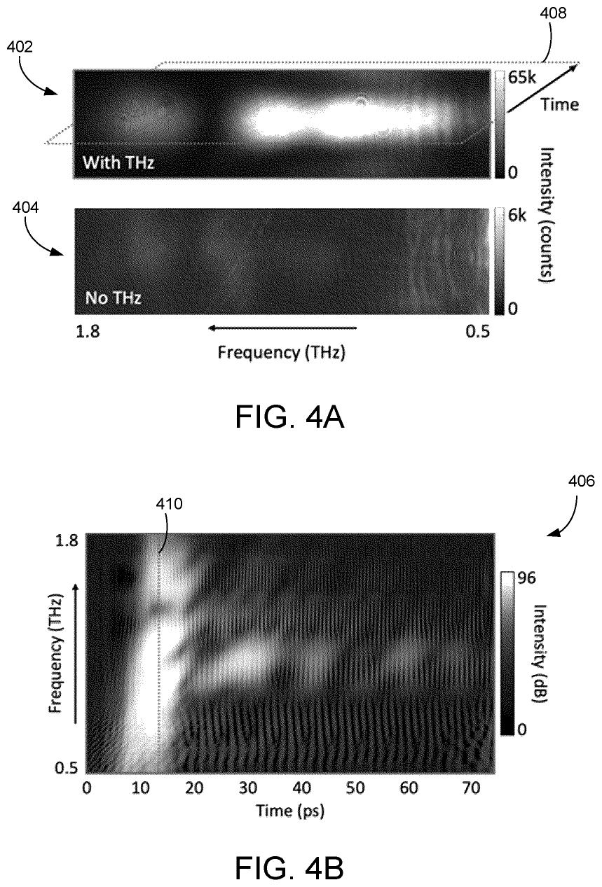

Referring now to FIG. 4A and FIG. 4B, results obtained using the systems and methods described herein will now be described in accordance with one embodiment. In one example, the system 210 of FIG. 2B is used to detect terahertz pulses using the image acquisition device 108 set to 50 frames per second (FPS) and synchronized to a mechanical chopper (not shown) to generate images with terahertz waves (also referred to herein as “On” images) and images without terahertz waves (also referred to herein as “Off” images). In this example, the integration time was set to 1 ms, which corresponds to 25 laser pulses per image. In total, 1833 background-subtracted images were taken over a time range of 73 ps and with a time step of 40 fs (i.e. without averaging).

FIG. 4A shows an image 402 of an of up-converted signal induced by broadband terahertz waves (as in 104 in FIG. 1A) hitting the nonlinear medium (reference 106 in FIG. 2B), e.g. a lithium niobate crystal. FIG. 4A further shows an image 404 of the background information without terahertz waves. FIG. 4B shows in plot 406 the time projection (corresponding to the dotted line 408 in FIG. 4A) of the up-converted terahertz signal captured by the image acquisition device 108 at 50 FPS after removing the background information. In FIG. 4B, frequencies lower than 0.5 THz have not been recorded because they are spatially close to the optical pump. In some embodiments, an optical density filter (not shown) may be used to limit saturation of the image acquisition device 108 by the up-converted signal. The high intensity observed at about 11 ps in FIG. 4B corresponds to the peak of the terahertz pulse electric field, which also has the largest frequency range. The dotted line 410 in FIG. 4B corresponds to the temporal position of the images in FIG. 4A. From FIG. 4B, it can be noted that the converted NIR signal strongly resembles an optical wavelet transform of terahertz photons where the time gate is dictated by the pump beam with a pulse duration of 300 fs.

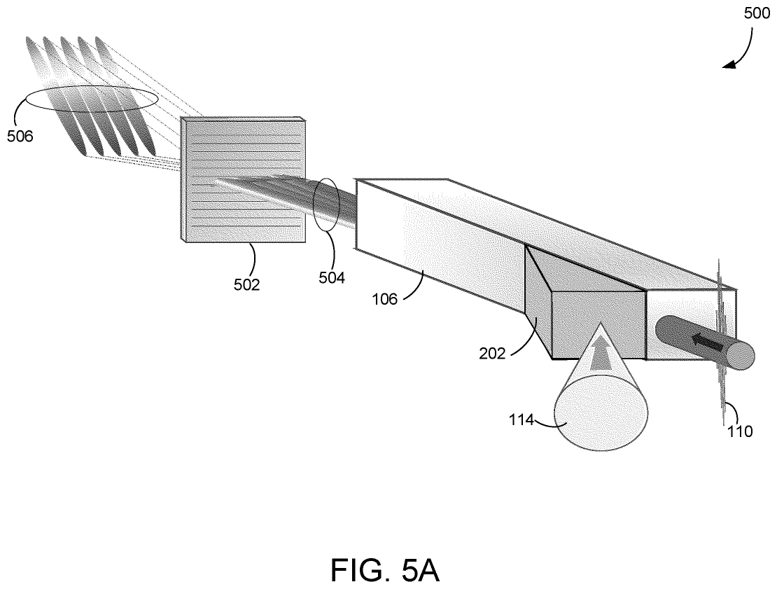

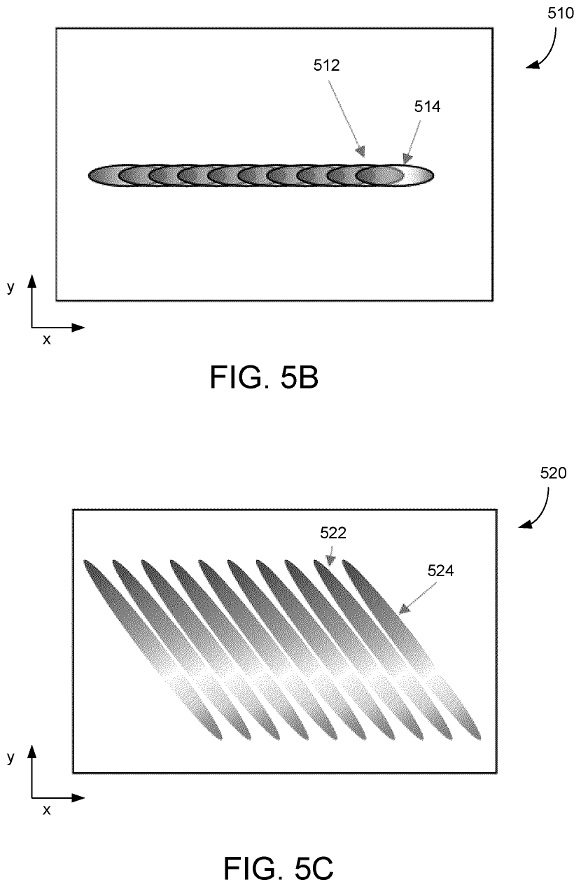

Referring now to FIG. 5A, a system 500 for parametric detection of terahertz pulses using diffraction grating will now be described, in accordance with an embodiment. The system 500 may be used to improve frequency resolution, which may be limited by the overlap of adjacent wavelength components when systems such as the system 100 of FIG. 1A, the system 200 of FIG. 2A, or the system 210 of FIG. 2B are used. The system 500 may allow to further separate the Stokes light (i.e., the up-converted signals 116₁, 116₂, . . . , 116_{N} in FIGS. 1A and 1B) using diffraction gratings. For this purpose, the system 500 comprises a diffraction grating 502 positioned in a direction perpendicular to the already spatially separated direction. In one embodiment, it is desirable for the diffraction grating 502 to have a high diffraction efficiency at the Stokes frequency. Other embodiments may apply. In the embodiment of FIG. 5, the system 500 comprises an Si prism 202 but it should be understood that the prism 202 may be omitted, as described herein above with reference to FIG. 1A.

Referring now to FIGS. 5B and 5C in addition to FIG. 5A, the overlap of adjacent wavelength components when no diffraction grating 502 is used can be seen in the schematic 510 of FIG. 5B where the wavelength components are only separated along the horizontal (or x) axis by non-collinear phase matching conditions (as described herein above with reference to FIGS. 1A and 1B). For example, the wavelength component at 1.50 Thz (labelled 512 in schematic 510) can be seen to overlap with the wavelength component at 1.51 THz (labelled 514 in schematic 510) along the horizontal axis. When the diffraction grating 502 is used, each up-converted signal (reference 116₁, 116₂, . . . , 116_{N} in FIG. 1A) forming a pulse front 504 is diffracted by the diffraction grating 502, resulting in a tilt of the pulse front 504. An inclined pulse front 506 is then obtained. As can be seen in the schematic 520 of FIG. 5C, by using the diffraction grating 502, it may be possible to separate each wavelength component in a different axial direction (i.e. along both the horizontal, or x, axis by non-collinear phase matching conditions and the vertical, or y, axis perpendicular to the horizontal axis by the diffraction grating 502) without degrading the separation based on the original angular phase matching condition between the laser pulse 110 and the terahertz radiation beam 114. For example, the wavelength component at the 1.50 THz wavelength (labelled 522 in schematic 520) is now separated (along both the horizontal and vertical axes) from the wavelength component at the 1.51 THz wavelength (labelled 524 in schematic 520), thus eliminating overlap and improving frequency resolution.

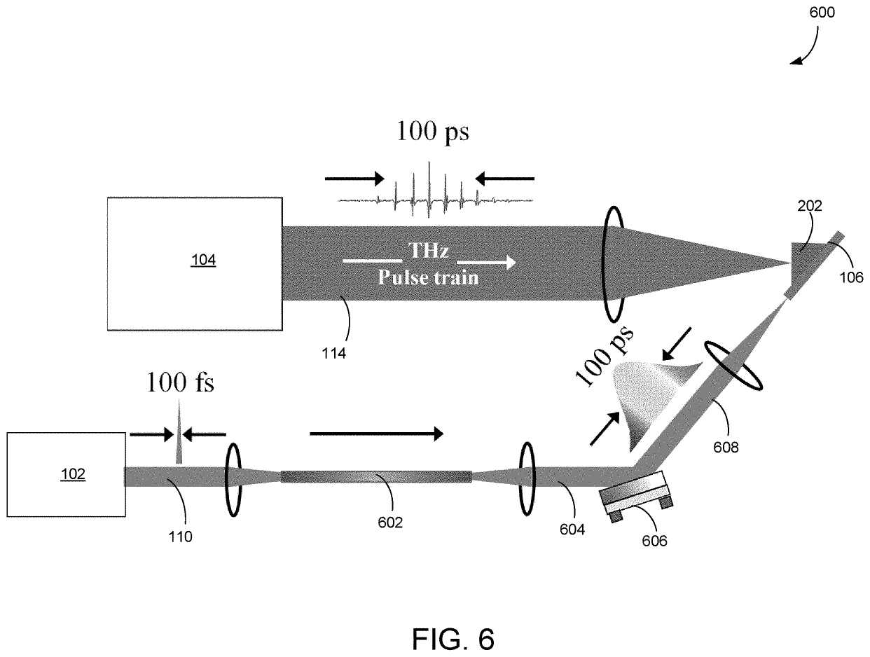

Referring now to FIG. 6, an example system 600 for parametric detection of terahertz pulses using a chirped pump beam will now be described, in accordance with one embodiment. By inserting a chirped pump beam, the system 600 may allow different wavelengths to undergo a non-linear interaction at a specific time. In this manner, the system 600 may convert the temporal information contained in the incident terahertz radiation beam 114 into infrared spatial information, which may be recorded using an image acquisition device (reference 108 in FIG. 1A), such as a conventional CCD camera. For this purpose, the system 600 comprises a chirping device 602 which is interposed between the laser source 102 and the nonlinear optical medium 106. Any suitable chirping device may be used. The chirping device 602 is configured to receive the laser pulses as in 110 generated by the laser source 102 as an input, and to output a chirped pump beam 604. The chirped pump beam 604 is then diffracted by a diffraction grating 606 which is also interposed between the laser source 102 and the nonlinear optical medium 106, and more specifically between the chirping device 602 and the nonlinear optical medium 106. The diffraction of the chirped pump beam 604 by the diffraction grating 606 occurs in a manner similar to that described above with reference to FIG. 5 and results in generation of a spectral chirped beam 608 that is input into the nonlinear medium 106.

In the embodiment of FIG. 6, the system 600 comprises an Si prism 202 but it should be understood that such a prism 202 may be omitted, as described herein above with reference to FIG. 1A. The spectral chirped beam 608 then interacts with the incident terahertz radiation beam 114 to generate multiple up-converted signals (not shown) in the manner described herein above with reference to FIG. 1A. In the example of FIG. 6, the laser source 102 is configured to emit laser pulses 110 of 110 fs, the terahertz radiation emitter 104 is configured to emit a terahertz pulse train containing terahertz radiation beams 114 of 100 ps, and the grating 502 generates a spectral chirped beam 608 of 100 ps. It should however be understood that this is for illustrative purposes and that other embodiments may apply.

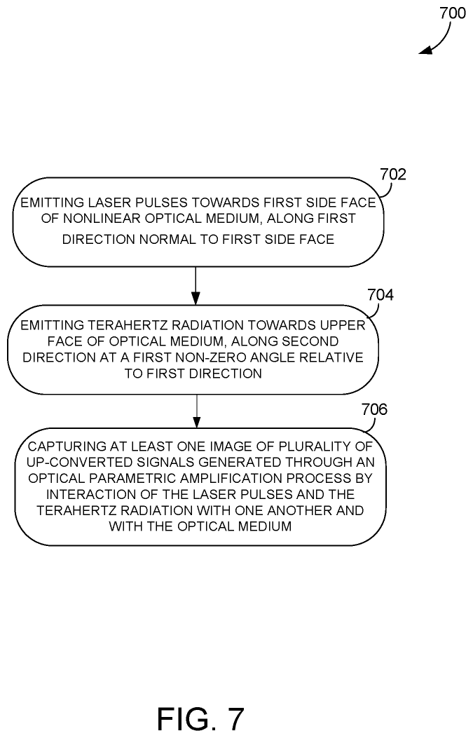

Referring now to FIG. 7, a method 700 for parametric detection of terahertz pulses, for instance using the system 100 of FIG. 1A, the system 200 of FIG. 2A, or the system 210 of FIG. 2B, will now be described. At step 702, the method 700 comprises emitting a plurality of laser pulses towards a first side face of an optical medium made of a nonlinear material, along a first direction normal to the first side face. The nonlinear optical medium may be as described above with reference to FIG. 1A (e.g., the nonlinear optical medium 106) and the laser pulses may be emitted using a laser source, such as the laser source 102 described above with reference to FIG. 1A. At step 704, the method 700 comprises emitting terahertz radiation towards an upper face of the optical medium, along a second direction at a first non-zero angle relative to the first direction. This may be achieved using a terahertz radiation emitter, such as the emitter 104 described above with reference to FIG. 1A. As described herein above, the plurality of laser pulses and the terahertz radiation are configured to synchronously propagate within the optical medium and to interact with one another and with the optical medium to generate a plurality of up-converted signals. As described above, the up-converted signals are generated through an optical parametric amplification process. The plurality of up-converted signals exit the optical medium at a second side face opposite to the first side face, along a plurality of third directions at a plurality of respective second non-zero angles relative to the first direction. At step 706, the method 700 comprises capturing at least one image of the plurality of up-converted signals, e.g. using an image acquisition device such as the device 108 described above with reference to FIG. 1A.

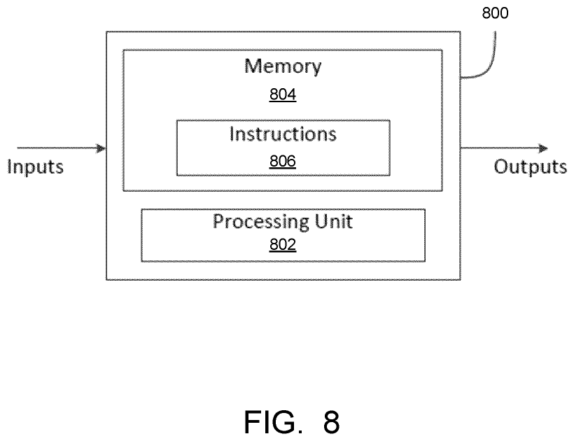

With reference to FIG. 8, part or all of the embodiments of the devices, systems and methods described herein may be implemented in a combination of both hardware and software. FIG. 6 illustrates an example computing device 800 which may be used to implement the system 100 of FIG. 1A, the system 200 of FIG. 2A, the system 210 of FIG. 2B, the system 300 of FIG. 3, the system 500 of FIG. 5, the system 600 of FIG. 6, and/or the method 700 of FIG. 7. The computing device 800 comprises a processing unit 802 and a memory 804 which has stored therein computer-executable instructions 806. The processing unit 802 may comprise any suitable devices configured to implement the functionality of the systems 100, 200, 210, 300, 500, 600 and/or the method 700 such that instructions 806, when executed by the computing device 800 or other programmable apparatus, may cause the functions/acts/steps performed by the systems 100, 200, 210, 300, 500, 600 and/or the method 700 as described herein to be executed. The processing unit 802 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, custom-designed analog and/or digital circuits, or any combination thereof.

The memory 804 may comprise any suitable known or other machine-readable storage medium. The memory 804 may comprise non-transitory computer readable storage medium, for example, but not limited to, an electronic, magnetic, optical, electromagnetic, infrared, or semiconductor system, apparatus, or device, or any suitable combination of the foregoing. The memory 804 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 804 may comprise any storage means (e.g., devices) suitable for retrievably storing machine-readable instructions 806 executable by processing unit 802.

The computing device 800 may be any suitable computing device, such as a desktop computer, a laptop computer, a mainframe, a server, a distributed computing system, a portable computing device, a mobile phone, a tablet, or the like.

In some embodiments, using the systems and methods described herein, it may be possible to acquire direct frequency information without acquiring time waveforms, allowing for high signal-to-noise ratio and real-time spectroscopy to be realized over a wide frequency band. In particular, real-time spectroscopy of ultra high-power terahertz waves, such as those from synchrotrons, may be achieved. Indeed, very high power terahertz light sources typically have a slow repetition rate (sometimes less than 1 Hz), which requires a long measurement time to sufficiently increase the signal-to-noise ratio with conventional detection methods, making real-time measurement impossible. The systems and methods described herein may be used to detect terahertz waves with a sufficient signal-to-noise ratio and in a single shot measurement scheme, thus proving useful as a detector in basic science fields. In some embodiments, real-time high-resolution wavelet analysis (i.e., frequency-by-frequency analysis of temporal variations in electric fields) may also be achieved using the systems and methods described herein. In addition, real-time measurement of temporal waveforms (e.g., for use in next-generation high-speed communications such as 5G) may be achieved using chirp pulses (e.g., as described herein above with reference to FIG. 6). Such real-time waveform measurement may be applicable to demodulation of terahertz pulse trains used in packet communications. Furthermore, the systems and methods described herein may, in some embodiments, be used for shielding spectroscopy (i.e. measurements through shielding). The systems and methods described herein may also, in some embodiments, be applied to quantum detection (i.e. as an ultra-sensitive terahertz wave detector) which uses up-conversion detection where photons are generated from photons.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A system for terahertz pulse detection, the system comprising:
an optical medium having an upper face, a first side face, and a second side face opposite the first side face, the optical medium made of a nonlinear material;
a broadband laser source configured to emit a plurality of laser pulses towards the first side face of the optical medium, along a first direction normal to the first side face;
a terahertz radiation emitter configured to emit terahertz radiation towards the upper face of the optical medium, along a second direction at a first non-zero angle relative to the first direction, the plurality of laser pulses and the terahertz radiation configured to synchronously propagate within the optical medium and to interact with one another and with the optical medium to generate a plurality of up-converted signals that exit the optical medium at the second side face, along a plurality of third directions at a plurality of respective second non-zero angles relative to the first direction; and
an image acquisition device configured to capture at least one image of the plurality of up-converted signals.

2. The system of claim 1, wherein the plurality of laser pulses and the terahertz radiation are configured to interact with one another and with the optical medium to generate the plurality of up-converted signals through an optical parametric amplification process.

3. The system of claim 1, wherein the optical medium is made of the nonlinear material selected from the group consisting of lithium niobate (LiNbO₃), lithium tantalite (LiTaO₃), and lithium triborate (LiB₃O₅).

4. The system of claim 1, wherein the laser source is a femtosecond laser configured to generate a plurality of femtosecond laser pulses.

5. The system of claim 4, wherein the laser source is one of an Ytterbium-doped laser, a Ti:Sapphire laser, and an Erbium laser.

6. The system of claim 1, wherein the image acquisition device is one of a charge-coupled device (CCD) camera and a scientific-grade complementary metal-oxide-semiconductor (sCMOS) camera.

7. The system of claim 1, further comprising a coupling medium for coupling the terahertz radiation to the optical medium, the terahertz radiation emitter configured to input the terahertz radiation into the optical medium through the coupling medium.

8. The system of claim 7, wherein the coupling medium is a triangular-shaped silicon prism positioned on the upper face of the optical medium.

9. The system of claim 1, further comprising at least one optical device configured to collect the terahertz radiation emitted by the terahertz radiation emitter and to collimate and refocus the terahertz radiation onto the optical medium.

10. The system of claim 9, wherein the at least one optical device comprises an off-axis mirror unit positioned at a distance from the optical medium.

11. The system of claim 1, further comprising a diffraction grating positioned at a distance from the optical medium, the diffraction grating configured to receive a pulse front comprising the plurality of up-converted signals exiting the optical medium and to diffract the plurality of up-converted signals to generate an inclined pulse front, wherein wavelength components associated with the pulse front are spatially separated along a first axis through the optical parametric amplification process, further wherein the wavelength components associated with the inclined pulse front are separated by the diffraction grating along a second axis perpendicular to the first axis.

12. The system of claim 1, further comprising a chirping device and a diffraction grating interposed between the laser source and the optical medium, wherein the chirping device is configured to receive the plurality of laser pulses from the laser source and to output a chirped pump beam to the diffraction grating, further wherein the diffraction grating is configured to diffract the chirped pump beam to generate a spectral chirped beam for input into the optical medium.

13. The system of claim 1, further comprising a lens interposed between the optical medium and the image acquisition device, the lens configured to spatially separate the plurality of up-converted signals that exit the optical medium for imaging the up-converted signals onto the image acquisition device.

14. A method for terahertz pulse detection, the method comprising:
emitting a plurality of laser pulses towards a first side face of an optical medium made of a nonlinear material, along a first direction normal to the first side face;
emitting terahertz radiation towards an upper face of the optical medium, along a second direction at a first non-zero angle relative to the first direction, the plurality of laser pulses and the terahertz radiation configured to synchronously propagate within the optical medium and to interact with one another and with the optical medium to generate a plurality of up-converted signals that exit the optical medium at a second side face opposite to the first side face, along a plurality of third directions at a plurality of respective second non-zero angles relative to the first direction; and
capturing at least one image of the plurality of up-converted signals.

15. The method of claim 14, wherein the plurality of laser pulses and the terahertz radiation interact with one another and with the optical medium to generate the plurality of up-converted signals through an optical parametric amplification process.

16. The method of claim 14, wherein emitting the terahertz radiation comprises coupling the terahertz radiation to the optical medium via a coupling medium.

17. The method of claim 14, further comprising using at least one optical device to collect the terahertz radiation emitted by the terahertz radiation emitter and to collimate and refocus the terahertz radiation onto the optical medium.

18. The method of claim 15, further comprising:
receiving, at a diffraction grating, a pulse front comprising the plurality of up-converted signals exiting the optical medium, wherein wavelength components associated with the pulse front are spatially separated along a first axis through the optical parametric amplification process; and
diffracting, at the diffraction grating, the plurality of up-converted signals to generate an inclined pulse front, wherein the wavelength components associated with the inclined pulse front are separated along a second axis perpendicular to the first axis.

19. The method of claim 14, further comprising:
receiving, at a chirping device, the plurality of laser pulses from the laser source and outputting a chirped pump beam to a diffraction grating; and
diffracting, at the diffraction grating, the chirped pump beam to generate a spectral chirped beam for input into the optical medium.

20. The method of claim 14, further comprising spatially separating, using a lens interposed between the optical medium and the image acquisition device, the plurality of up-converted signals that exit the optical medium for imaging the up-converted signals onto an image acquisition device configured to capture the at least one image of the plurality of up-converted signals.
